(19) United States
(12) Patent Application Publication
(10) Pub. No.: US 2007/0266561 A1
(43) Pub. Date: Nov. 22, 2007

(54) Stone-setting preparatory process and system

(76) Inventor: Alexis Mivelaz, Bogis-Bossey (CH)

Correspondence Address: HARNESS, DICKEY & PIERCE, P.L.C., P.O. BOX 8910, RESTON, VA, 20195, US

(21) Appl. No.: 11/797,518

(22) Filed: May 4, 2007

(30) Foreign Application Priority Data
May 5, 2006 (EP) 06113575.2

(51) Int. Cl. G04D 3/00; B23P 25/00

(52) U.S. Cl. 29/896.32; 29/896.3

(57) ABSTRACT

The present invention, in at least one embodiment, concerns a process for the multiple marking out of stone seating on a setting surface, in particular on a watchcase middle, and a kit for using at least one embodiment of the invention in a multiple marking-out process.

### TECHNICAL FIELD

The present invention concerns the field of stone-setting preparation in jewelry, clock and watch making. More specifically, it concerns a process for the multiple marking out of stone seating on a setting surface, in particular on a watchcase middle, and a kit for using the invention in a multiple marking-out process.

### PRIOR ART

In the jewelry or clock and watch making field, it is well known that setting of stones in a mount of any shape is achieved by executing, in the mount itself, holes designed to receive the stones to be set.

Drilling out of holes in the mount requires accurate preliminary marking-out of the position of the stone and marking of its location to indicate the drilling position, a position generally corresponding to the center of the hole to be executed. In the case of multiple settings, execution of holes requires in addition preliminary setting out of the stones (definition of stone setting) on the mount, setting out all the more complicated since the size and possibly the shape of the stones used vary. In general, marking of the location of the stones is performed using an instrument tip, for example a punch or graver. The setting surface is then subjected to drilling at the locations marked for the holes, the stones are placed in the cavities and are then set.

Current manual methods of marking-out stone locations prior to setting have the disadvantage of not allowing visual setting out of all stones on the setting support during marking work and of providing only an indication of the position of the center of the stone to be set.

Three-dimensional modeling (computer-aided design/manufacturing or CAD/CAM) of the jewelry or clock and watch making object has been developed within the scope of stone-setting preparatory work. This technique ensures piloting of simultaneous 5-axis machining of stone recesses (hole bombardment) through digital control. This technique is used for drillings designed to receive stones and for creating holes or re-cutting. Stone setting work is hand-finished, usually using gravers.

However, use of this system presupposes that the shape of the middle of the final object can be defined in terms of primitive geometrical shapes available in CAD/CAM (planes, cones, cylinders, spheres, etc.) (patent application no FR 2545241). If this is not the case, the CAD model does not correspond accurately enough to the middle of the desired object. An alternative in the preceding case is to prepare manually a prototype, in which stone setting is also performed manually, then to produce a casting, which is used for modeling the virtual model, the virtual model being thereby used to produce several models in series by digital control.

As a result, computer-aided stone-setting preparatory methods are not suitable for producing pieces with complex shapes, pieces whose size and shape of stone are variable, prototypes, single or very small-series pieces for which investment in digital modeling is undesirable in terms of cost and development time.

It is therefore desirable to develop new techniques for the accurate marking out of stone seating on a setting surface, which are particularly suitable for the preparation of prototypes or small series.

### DESCRIPTION OF THE INVENTION

The present invention proposes to overcome the unresolved problem of the multiple, accurate marking out of the whole stone seating on a setting surface, suitable for the preparation of prototypes or small series.

The object of the invention is achieved by a stone-setting preparatory process allowing marking out of all stones on the setting surface, comprising the following steps:
(1) selection of a stone marking-out dot;
(2) picking up of the selected stone marking dot;
(3) depositing of the stone marking-out dot on the setting surface;
   wherein stone marking-out dot selection is performed such that the diameter of the stone marking-out dot corresponds to the diameter of the recess for the stone to be set.

The solution to the problem is also provided a marking-out kit containing marking-out dots of different diameters corresponding to those of the recesses for the stones to be set and comprising different compartments separating the marking-out dots according to their diameter and/or color.

The marking-out process implemented by the invention then allows bombardment of holes for stone setting at the position marked for each stone.

The marking-out process implemented by the invention is temporary, in other words it allows repositioning of the stone seating marks at any time during the process implemented by the invention and before final bombardment. This facilitates, in particular, creative work in preparing the prototype by allowing the choice of the type of stones and their positioning to be modified prior to bombardment.

The marking-out process implemented by the invention is particularly suitable for the preparation of prototypes or small series of jewelry, clock and watch making components.

The marking-out process implemented by the invention is also suitable for the production of jewelry, clock and watch making pieces of complex shape, comprising set stones.

### BRIEF DESCRIPTION OF DRAWINGS

The present invention and its advantages will be better understood with reference to the appended figures and the detailed description of a specific implementation, in which:

FIG. 1 illustrates the process implemented by the invention, in which marking-out dots of different diameters (2) mark stone seating on a setting surface of a watchcase (1) and the picking up step (3) for a marking-out dot using the instrument tip pf a punch (4) before its accurate depositing on the setting surface.

FIG. 2 illustrates the process implemented by the invention, in which marking-out dots of different diameters (2) mark stone seating on the setting surface of a watchcase viewed from the side.

FIG. 3 illustrates the kit according to the invention comprising marking-out dots of different diameters, shapes and colors. An example of marking of the center position of the dots is shown.

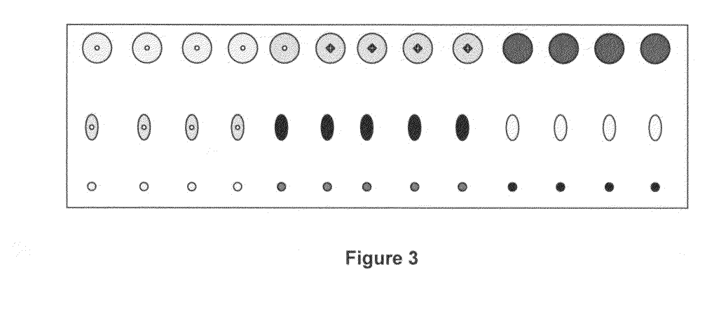

FIG. 4 illustrates a marking-out dot of the kit according to the invention.

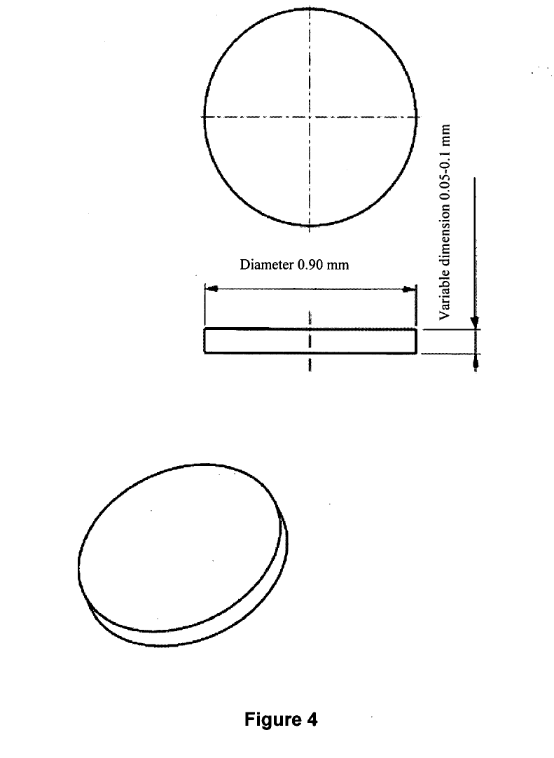

### INVENTION IMPLEMENTATION METHODS

The present invention will be better understood with reference to the following definitions.

By “setting”, we mean a process, which comprises setting or enchasing a stone in a metal mount. Setting is typically performed on steel, gold, platinum or silver or on alloys based on these metals. Main setting methods include claw setting, enclosed setting, closed back setting, grain setting, nail setting, rail setting, partition setting, hammer setting and mirage setting. Within the context of the invention, the term “setting” also comprises holding stones in recesses by gluing or pressure such as, for example, fixing stones in position between transparent plates, the bottom plate of which incorporates recessing of its surface for locating stones (a technique described in patent application n° FR 2646759).

The setting method is chosen according to the aesthetic effect sought, the final usage if the object, the type and shape of stone and the setting support. For example, a setting method such as the one described in patent application n° FR 2792508 can be used for setting soft stones in a hard support such as steel and a method such as the one described in patent application EP 955821 can be used, when setting in malleable materials. Other examples, which can be used, are described in patent application n° FR 2580155, EP 089906 and EP 367923.

Preparation, in other words marking out of the location of the stones, and placement of the stones in their locations is also called “stone setting”.

By “bombardment”, we mean not only marking of the recess locations for the stones, e.g. by mechanical action, but also drilling out of these recesses in the support. These recesses or sockets can be of different shapes and are usually created by drilling with a setting drill and milling designed to form appropriately positioned holes.

By “stone”, we also mean “gemstone”, in other words so-called “precious” stones, such as diamond, emerald, ruby or sapphire, so-called semi-precious stones, such as aquamarine, amethyst, citrine, rock crystal, cordierite, druse, garnet, peridot, tanzanite, topaz, tourmaline and zircon, and so-called “ornamental” stones, such as agate, amber, azurite, chalcedony, coral, cornelian, hematite, jade, jet, jasper, lapis lazuli, malachite, marcasite, obsidian, onyx, pearl, moonstone, sard, spinel, quartz, opal, iolite and turquoise, and synthetic stones, such as moissanite.

By “dot”, we mean an element of definite shape, whose diameter corresponds to the cavity required to locate the stone to be set, in other words the diameter of the dot can be exactly the same as the diameter of the recess for the stone to be set or can take into account the space between recesses. Generally of circular shape, the dot can also be, for example, of oval, hexagonal, square or rectangular shape. The dot can be colored and its color can either be representative of the color of the stone or can correspond to a color code associated with the diameter of the dot or of the stone to be set. Better visualization of the final appearance in color of the stone setting layout on the support is obtained, when the color of the dot is representative of the color of the stone to be set. The required number of stones of a certain diameter and, for example, the final cost of stone setting layout can be more easily calculated before bombardment, when the color of the dot is representative of the diameter of the stone to be set.

By “picking up”, we mean taking hold of an element to allow its displacement and positioning at a desired location.

By “compartment” within the scope of the kit according to the invention, we mean a separation means, such as material separation (for example, a division, a cell or a box) in the kit itself or physical division (for example using a removable element such as a sheet, a film or a separator).

According to the invention, the stone-setting preparatory process allowing marking out of all stones on the setting surface comprises the following steps:
(1) selection of a stone marking-out dot;
(2) picking up of the selected stone marking-out dot;
(3) depositing of the stone marking-out dot on the setting surface;
   wherein stone marking-out dot selection is made such that the diameter of the stone marking-out dot corresponds to the diameter of the recess for the stone to be set.

According to one aspect of the process implemented by the invention, the diameter of the dot takes into account the space between recesses for the stones to be set. In this case, depositing of dot is performed such that they are abutting.

Steps (2 and 3) are repeated as many times as required with a new dot selected in step (1) to mark out part of or the entire stone setting layout on the setting surface.

According to one aspect of the process implemented by the invention, each dot deposited in step (3) can be picked up again at any time and repositioned at another location on the setting surface or be discarded.

According to one aspect of the process implemented by the invention, said process comprises an additional step of bombarding or marking the setting surface at the center of each dot, preferably after marking out with the dots the entire stone setting layout on the setting surface.

According to another aspect of the process implemented by the invention, the selected marking-out dot is a colored dot and the color of the dot is representative of the color of the stone to be set.

The dot can be made of different materials such as, for example, paper, plastic or bonded fibers.

Depending on the type of dot, its thickness and possible impregnation with bonding agents, a choice of dots of different stiffness can be obtained to ensure good adherence of the dot to the setting surface such as, for example, on surfaces that are vertical or not flat, as well as ease of picking up and depositing. A dot has typically a thickness selected from 0.05; 0.06; 0.07; 0.08; 0.09 or 0.1 mm.

Typically, the dots of the invention have a diameter selected from 0.7; 0.71; 0.72; 0.73; 0.74; 0.75; 0.76; 0.77; 0.78; 0.79; 0.8; 0.81; 0.82; 0.83; 0.84; 0.85; 0.86; 0.87; 0.88; 0.89; 0.90; 0.91; 0.92; 0.93; 0.94; 0.95; 0.96; 0.97; 0.98; 0.99; 1; 1.1; 1.2; 1.3; 1.4; 1.5; 1.6; 1.7; 1.8; 1.9; 2.0; 2.1; 2.2; 2.3; 2.4; 2.5; 2.6; 2.7; 2.8; 2.9; 3.0; 3.1; 3.2; 3.3; 3.4; 3.5; 3.6; 3.7; 3.8; 3.9; 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9 or 6.0 mm.

Typically, the dots of the invention have a diameter selected from 0.9; 1.0; 1.1; 1.2; 1.3; 1.4; 1.5; 1.6; 1.7; 1.8; 1.9; 2.0; 2.1; 2.2; 2.3 or 2.4 mm.

According to another aspect of the process implemented by the invention, the dots can feature a mark indicating the position of their center on at least one of their faces (for example by a microhole, a cut-out or a printed mark such as a cross, for example).

According to the process implemented by the invention, the steps involving picking up and depositing the marking-out dot can be performed by different methods such as, for example, by electrostatic effect for a plastic dot, using a metal instrument to position accurately the dot, by suction effect using a micropipette or negation air pressure micro-suction cup, by contact effect using a instrument tip, for example a punch or a graver, or by gripping with tweezers.

According to a particular usage of the process implemented by the invention, different methods of fixing reversibly the marking-out dot to the setting surface can be used, such as a method of fixing by thermostatic or reversible adhesive effect, for example.

A method of fixing by thermostatic effect can either result from interaction of the dot with the setting surface, depending on the type of dot chosen, or be induced by using an electrostatic spray applied to the setting surface before the step of depositing the dot on the surface.

A method of fixing by reversible adhesive effect can result either from using a reversible adhesive material on the support, for example by using a spray containing a reversible adhesive on the setting support before the step of depositing the dot on this surface, or from presence of an adhesive on the dot itself (adhesive dot), preferably only on the face to be deposited on the setting surface.

In the case of an adhesive marking-out dot, the adhesive can be, for example, a repositionable adhesive or a thermo-adhesive, whose adhesive properties are activated thermal action (for example, a flame, a lamp or a heating unit). Repositionable adhesive is particularly suitable for preparing a prototype, whilst thermo-adhesive is particularly suitable for a case in which the prototype or piece is not bombarded on the spot and must be moved to another location for machining, for example.

According to the process implemented by the invention and in a case, in which the dot selected in step (1) is a thermo-adhesive dot, the process implemented by the invention comprises an additional heating step between the steps involving picking up and depositing of the dot on the setting surface.

The setting surface prepared according to the process implemented by the invention can then be easily subjected to a process involving conventional bombarding and machining of the recesses for the stones.

In an additional implementation of the invention, it is also possible to provide, after the step of depositing each marking-out dot on the setting surface, an optical, preferably colored (for example binocular) marking-out system for the position of the dots, connected to a system of digitization and memorization of the position of the marking-out dots according to the invention. This marking out is all the easier if the dots feature a mark indicating the position of their center on their visible face. The digitized positions can then be used for digitally controlling the toolpaths of a multi-axis machining tool, as described in patent application n° FR 2545241 for example, with a view to bombarding and without having to resort to a stone-set or bombarded prototype.

The invention also comprises a marking-out kit containing marking-out dots of different diameters corresponding to those of the recesses for the stones to be set and comprising different compartments separating the marking-out dots according to their diameter and/or color.

According to an aspect of the invention, the kit comprises colored marking-out dots, wherein the color is representative of the diameter of the stone to be set.

According to an aspect of the invention, the kit comprises colored marking-out dots, wherein the dots can all be of the same color or of different colors and wherein the color is representative of the color of the stone to be set.

According to another aspect of the invention, the kit comprises marking-out dots, wherein the dots are adhesive dots and wherein the adhesive is a repositionable adhesive and is only present on one face.

According to an aspect of the invention, the kit comprises marking-out dots, wherein the dots are thermo-adhesive dots and wherein the thermo-adhesive is only present on one of the faces of the dot.

According to another aspect of the invention, the kit comprises marking-out dots with diameters selected from 0.7; 0.71; 0.72; 0.73; 0.74; 0.75; 0.76; 0.77; 0.78; 0.79; 0.8; 0.81; 0.82; 0.83; 0.84; 0.85; 0.86; 0.87; 0.88; 0.89; 0.90; 0.91; 0.92; 0.93; 0.94; 0.95; 0.96; 0.97; 0.98; 0.99; 1; 1.1; 1.2; 1.3; 1.4; 1.5; 1.6; 1.7; 1.8; 1.9; 2.0; 2.1; 2.2; 2.3; 2.4; 2.5; 2.6; 2.7; 2.8; 2.9; 3.0; 3.1; 3.2; 3.3; 3.4; 3.5; 3.6; 3.7; 3.8; 3.9; 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9 or 6.0 mm.

According to another aspect of the invention, the kit comprises marking-out dots with diameters selected from 0.9; 1.0; 1.1; 1.2; 1.3; 1.4; 1.5; 1.6; 1.7; 1.8; 1.9; 2.0; 2.1; 2.2; 2.3 or 2.4 mm and wherein the dots can all be of the same diameter or of different diameters.

According to another aspect of the invention, the kit comprises marking-out dots with selected thicknesses between 0.05, 0.06, 0.07, 0.08, 0.09 and 0.1 mm.

According to the kit of the invention, the marking-out dots can feature a mark indicating the position of their center on at least one of their faces (for example, a micro-hole, a cut-out or a printed mark such as a cross, for example).

According to the kit of the invention, the marking-out dots are made of materials selected from paper, plastic or bonded fibers.

According to another aspect of the invention, the kit comprises marking-out dots presented in a box, typically 10 to 200 repositionable adhesive dots, the dots being, for example, presented in the kit such that their adhesive surface adheres to a support in the kit box.

The invention is obviously not limited in its application to clock and watch making pieces such as clocks and watches, but also applies to manufacturing of jewelry pieces such as rings, bracelets, necklaces, earrings, head-dress ornaments and pendants, spectacles and ornamental items such as mirror frames.

Naturally, other implementation methods available to a person skilled in the art could have been envisaged, for all that without exceeding the scope of the invention.

### EXAMPLE 1

### Stone Marking-Out Process on a Watchcase Setting Surface

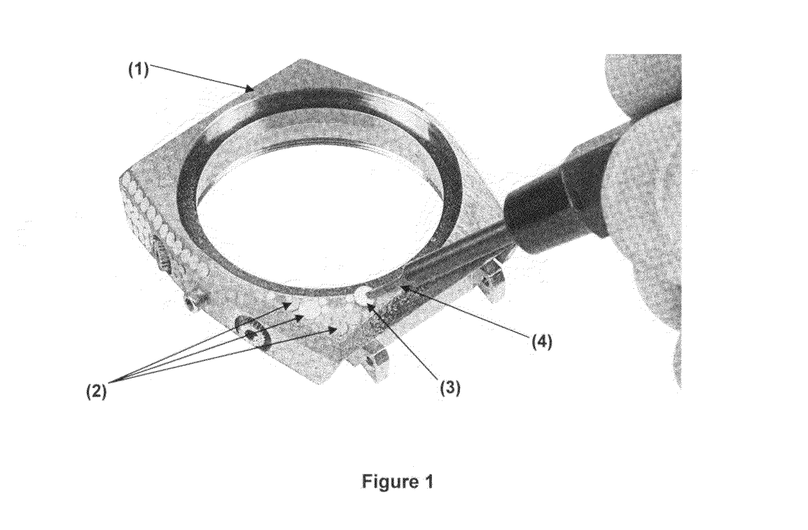

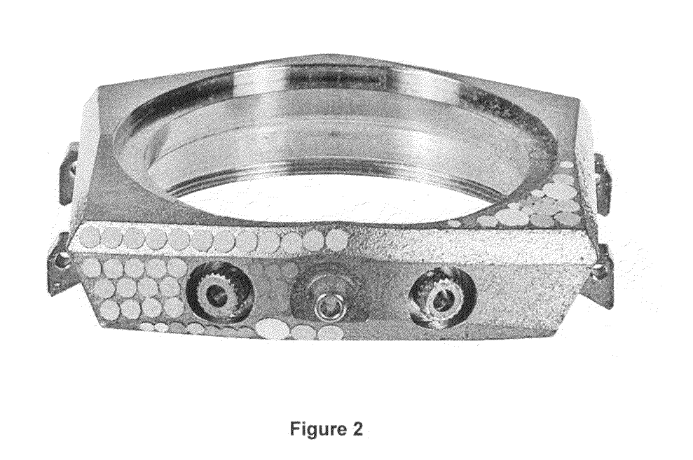

The process implemented by the invention is illustrated by performing stone-setting preparatory work on a watchcase according to the method of the invention.
(1) 0.05-0.1 mm thick paper dots/discs are selected one by one with a diameter corresponding to the recesses/pockets (0.9-2.4 mm) for the stones to be set in addition to the space between the recesses. The color of the dots corresponds to a given dot diameter.
(2) Each dot is picked up using an instrument tip (FIG. 1).
(3) Each dot is then deposited at the required location corresponding to the stone setting position, such that the dots/discs are abutting (FIGS. 1 and 2).
(4) The steps (2 and 3) are repeated as many times as necessary with a new dot selected in step (1) to ensure part of the stone setting layout on the surface of the watchcase (FIGS. 1 and 2).

1. A stone-setting preparatory process allowing marking out of all stones on the setting surface, comprising the following steps:
(1) selection of a stone marking-out dot;
(2) picking up of the selected stone marking-out dot;
(3) depositing of the stone marking-out dot on the setting surface; wherein stone marking-out dot selection is made such that the diameter of the stone marking-out dot corresponds to the diameter of the recess for the stone to be set.

2. The process as claimed in claim 1, wherein stone marking-out dot selection is performed such that the diameter of the stone marking-out dot is determined according to the diameter of the recess for the stone to be set and the space between recesses.

3. The process as claimed in claim 1, wherein the step (3) is followed by an additional step of bombarding or marking the setting surface at the center of each dot.

4. The process as claimed in claim 1, wherein the selected marking-out dot is a colored marking-out dot.

5. The process as claimed in claim 1, wherein the steps of picking up and depositing the marking-out dot are performed by electrostatic or suction effect, by using an instrument tip or by gripping.

6. The process as claimed in claim 1, wherein the marking-out dot is an adhesive dot.

7. The process as claimed in claim 1, wherein the selected marking-out dot is a thermo-adhesive dot and wherein the step (3) is preceded by an additional step of heating the dot.

8. The process as claimed in claim 1, wherein the step (3) is preceded by applying an electrostatic spray or repositionable adhesive to the setting surface.

9. Process as claimed in claim 1, wherein the marking-out dot is a dot, whose material is selected from paper, plastic or bonded fibers.

10. A marking-out kit containing marking-out dots of different diameters corresponding to those of the recesses for the stones to be set and comprising different compartments separating the marking-out dots according to their diameter and/or color.

11. A kit as claimed in claim 10, wherein the marking-out dots are colored and wherein the color of the marking-out dots is representative of the color of the stone to be set or the diameter of the dot.

12. A kit as claimed in claim 10, wherein the dots feature a mark indicating the position of their center on at least one of their faces.

13. A kit as claimed in claim 10, wherein the marking-out dots have diameters selected from 0.7; 0.71; 0.72; 0.73; 0.74; 0.75; 0.76; 0.77; 0.78; 0.79; 0.8; 0.81; 0.82; 0.83; 0.84; 0.85; 0.86; 0.87; 0.88; 0.89; 0.90; 0.91; 0.92; 0.93; 0.94; 0.95; 0.96; 0.97; 0.98; 0.99; 1; 1.1; 1.2; 1.3; 1.4; 1.5; 1.6; 1.7; 1.8; 1.9; 2.0; 2.1; 2.2; 2.3; 2.4; 2.5; 2.6; 2.7; 2.8; 2.9; 3.0; 3.1; 3.2; 3.3; 3.4; 3.5; 3.6; 3.7; 3.8; 3.9; 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9 or 6.0 mm.

14. A kit as claimed in claim 10, wherein the marking-out dots have diameters selected from 0.9, 1.0, 1.1, 1.2, 1.3, 1.4, 1.5, 1.6, 1.7, 1.8, 1.9, 2.0, 2.1, 2.2, 2.3 or 2.4 mm and wherein the dots are all of the same diameter or of different diameters.

15. A kit as claimed in claim 10, wherein the marking-out dots are of selected thicknesses between 0.05, 0.06, 0.07, 0.08, 0.09 and 0.1 mm.

16. A kit as claimed in claim 10, wherein the marking-out dots are made of materials selected from paper, plastic or bonded fibers.

17. A kit as claimed in claim 10, wherein the marking-out dots are adhesive dots, for which the adhesive is a repositionable adhesive and is only present on one face.

18. A kit as claimed in claim 10, wherein the dots are repositionable adhesive dots and are presented in the kit such that their adhesive surface adheres to a support in the kit box.

19. The process as claimed in claim 1, wherein the step (3) is followed by an additional step of bombarding or marking the setting surface at the center of each dot, after marking out the entire stone setting layout on the setting surface with the marking-out dots.
